(19) United States
(12) Patent Application Publication
(10) Pub. No.: US 2025/0388347 A1
(43) Pub. Date: Dec. 25, 2025

(54) VERTICAL TAKE-OFF AND LANDING UNMANNED AERIAL VEHICLES AND UNMANNED AERIAL SYSTEMS COMPRISING SUCH VEHICLES

(71) Applicant: Hagay BAR, Tel Aviv (IL)

(72) Inventor: Hagay BAR, Tel Aviv (IL)

(21) Appl. No.: 19/104,565

(22) PCT Filed: Aug. 11, 2023
(86) PCT No.: PCT/IB2023/058138

§ 371 Date: Feb. 18, 2025

(30) Foreign Application Priority Data
Aug. 17, 2022 (IL) 295691

(51) Int. Cl. B64U 10/20; B64U 20/80; B64U 30/12; B64U 30/297; B64U 40/20

(52) U.S. Cl. CPC B64U 10/20; B64U 30/12; B64U 30/297; B64U 40/20; B64U 20/80; B64U 2201/20

(57) ABSTRACT

Provided is a vertical take-off and landing unmanned aerial vehicle (VTOL UAV) comprising a body, a pair of wings pivotably attached to the body with at least one pair of front rotors mounted on the wings, a rear rotor pivotably attached to the body and, when in use, oriented vertically, a flight control unit accommodated in the body and comprising a receiver configured to receive a control signal and a controller configured to process the control signal to operate the front and rear rotors, a front operating motor connected with the pair of wings to turn them with respect to the body, a rear operating motor connected with the rear rotor to turn the rear rotor with respect to the body. The VTOL UAV combines vertical take-off and landing with horizontal flight at high speed and hovering at an angle with respect to the horizon, which results in higher efficiency, simplification of control and extended operating time.

### FIELD OF THE INVENTION

The present invention relates to unmanned aerial vehicles (UAVs), particularly to vertical take-off and landing unmanned aerial vehicles (VTOL UAVs) and unmanned aerial systems (UAS) comprising such vehicles.

### BACKGROUND OF THE INVENTION

VTOL UAVs are widely used in different fields such as transportation of goods, surveillance, mapping or entertainment industry, due to their ability to take-off and land vertically, as well as hover in the drone mode, when the rotors are oriented vertically, and commit gliding flight when the rotors are oriented horizontally.

Depending on the particular implementation, VTOL UAVs may carry different equipment such as camera, pyrotechnic lights, sensors etc. When VTOL UAV operates in the drone mode, there may be a need to turn the equipment with respect to the ground or the UAV's body to better fit the task implemented by the UAV, e.g. to cover particular surveying area or to direct the light to a particular point.

Conventional UAVs use pivot devices allowing the equipment to be turned to a desired position, for example camera gimbals. The pivot devices allow desired movement of the equipment, however the UAV's operation becomes more complicated as there is need to control the UAV and the pivot devices separately. In addition, such pivot devices add weight to UAVs thus reducing their operating time.

US 20150136897 discloses a VTOL UAV that can provide vertical take-off and landing and horizontal flight due to at least four rotors arranged in fixed wings. The UAV may hover to perform photo or video recording by a camera attached to the body of the UAV. However, the construction and operation of the UAV is complicated as the rotation of the camera is a separate operational task performed by a rotating mechanism mounted on the body of the UAV.

Known is a UAS comprising VTOL UAV produced by Wingtra (WingtraOne VTOL). The VTOL UAVs are able to take-off and land vertically, hover as a drone and commit horizontal flight, to perform data collection by a camera mounted in the body of the UAV. Such UAVs have two rotors arranged on wings and a pivotable rear part that allow for switching between the vertical take-off and landing mode and the horizontal flight mode. These UAVs are easy to operate as far as the camera is fixed with respect to the UAV's body, however they are not enough maneuverable so that the camera may not be arranged at an angle to the ground or to the body in the hover mode.

Therefore, the object of the present invention is to provide a VTOL UAV with a simple construction and increased maneuverability, which is easy to operate. Another object of the present invention is to extend operating time and increase flight range of VTOL UAV. Yet another object of the present invention is to provide a UAS comprising such VTOL UAV.

### SUMMARY OF THE INVENTION

The objects of the present invention are achieved by the VTOL UAVs and UAS's disclosed in the present disclosure. According to a first embodiment, the VTOL UAV comprises a body, a pair of wings pivotably attached to the body and at least one pair of front rotors mounted on the wings, wherein each of the front rotors comprises a motor and a propeller. The UAV further comprises a rear rotor pivotably attached to the body and, when in use, oriented vertically, the rear rotor comprises a motor and a propeller. When in operation, the UAV is controlled by a flight control unit accommodated in the body, the flight control unit comprises a receiver configured to receive a control signal and a controller configured to process the control signal received by the receiver to further operate the motors of the front and rear rotors. The UAV further comprises a front operating motor connected with the pair of wings to turn them with respect to the body and a rear operating motor connected with the rear rotor to turn the rear rotor with respect to the body. The controller is communicatively coupled with the front operating motor and the rear operating motor to operate them based on the control signal received by the receiver. The VTOL UAV further comprises a power source accommodated in the body and configured to supply power to the receiver and the controller of the flight control unit. The VTOL UAV of the above configuration is capable to hover at an angle to the horizon, meaning that, when hovering at an angle, the front and rear parts of the body of the VTOL UAV have different coordinates with regard to vertical axis Z. Therefore, the proposed UAV provides both, vertical take-off and landing and hovering at an angle having different Z-coordinates along its body, the claimed invention also can be referred as “VZ-TOL”. Conventional UAV's are unable to perform hovering at an angle as the claimed UAV does and, therefore, VTOL UAV or VZ-TOL UAV according to the present application provides increased maneuverability and possibilities to use equipment without additional pivot devices. Thus, the operation of the VTOL UAV is simplified whereas the VTOL UAV is lightened and its energy consumption and flight range are improved.

In one particular embodiment, the body of the VTOL UAV comprises a frame configured to accommodate the flight control unit, and the pair of wings is pivotably attached to the frame. The UAV further comprises a bar transversely passing through the body and rotatably mounted in the frame, wherein the wings of the pair of wings are fixedly connected to the bar, and the bar comprises a gear wheel. The front operating motor comprises a shaft and a gear wheel arranged thereon, wherein the gear wheel of the front operating motor engages (meshes) with the gear wheel of the bar. The front rotors comprise housings accommodating the motors, the housings of the front rotors are fixedly mounted on the opposite ends of the bar, and the rear rotor comprises a housing accommodating the motor of the rear rotor. The UAV further comprises an arm, wherein one end of the arm is pivotably connected to the housing of the rear rotor, and the other end of the arm is pivotably connected to the frame. The frame of the VTOL UAV comprises side walls, and the bar is rotatably mounted on the frame of the body by bearings mounted in the side walls.

The controller of the VTOL UAV flight control unit may control the front rotors and the rear rotor by feeding them with power received from the power source.

The front and the rear operating motors may be servomotors.

The receiver of the VTOL UAV flight control unit may be a GPS antenna.

According to a second embodiment, the VTOL UAV comprises a body, at least two pairs of wings pivotably attached to the body, comprising at least one pair of front wings and at least one pair of rear wings, at least one pair of front rotors mounted on the at least one pair of front wings, at least one pair of rear rotors mounted on the at least one pair of rear wings, wherein each of the rotors comprises a motor and a propeller. When in operation, the UAV is controlled by a flight control unit accommodated in the body, the flight control unit comprises a receiver configured to receive a control signal, and a controller configured to process the control signal received by the receiver and to operate the motors of the rotors. The VTOL UAV further comprises an operating motor connected with one pair of wings to turn them with respect to the body, wherein all pairs of wings are connected with each other to be simultaneously turned. The controller is communicatively coupled with the operating motor to operate it based on the control signal received by the receiver. The VTOL UAV further comprises a power source accommodated in the body and configured to supply power to the receiver and the controller of the flight control unit. The VTOL UAV of the above configuration is capable to hover at an angle providing increased maneuverability and possibilities to use equipment without additional pivot devices. At the same time, the construction of the VTOL UAV with only one operating motor provides additional simplifying of the operation of the VTOL UAV as well as additional lightening and improved energy consumption and flight range.

In one particular embodiment, the body of the VTOL UAV comprises a frame configured to accommodate the flight control unit, and the pairs of wings are pivotably attached to the frame. The VTOL UAV further comprises at least two bars transversely passing through the body and rotatably mounted in the frame, the number of the bars is equal to the number of the pairs of wings, the wings of each pair of wings are fixedly connected to the respective bar, and each bar comprises a gear wheel. Also, the VTOL UAV comprises a transmission unit movably arranged in the body. The operating motor comprises a shaft and a gear wheel arranged thereon, and the transmission unit is arranged to movably connect the gear wheels with each other. The frame comprises side walls and the bars are rotatably mounted on the frame of the body by bearings mounted in the side walls. Each of the front rotors and the rear rotors comprises a housing accommodating the motor of the respective rotors, and the housings are fixedly mounted on the opposite ends of the respective bar.

The controller of the VTOL UAV′ flight control unit may control the rotors by feeding them with power received from the power source.

The operating motor may be a servomotor.

The receiver of the VTOL UAV′ flight control unit may be a GPS antenna.

The present disclosure further relates to an unmanned aerial system (UAS), comprising the VTOL UAV according to the first embodiment, and a remote control panel configured to send control signals to control the operation of the VTOL UAV.

In one particular embodiment, the remote control panel may comprise a housing that accommodates an emitter, a controller configured to communicate with the emitter to send operating signals to the VTOL UAV, and a user interface communicatively connected to the controller and comprising a means for feeding commands to the controller.

The remote control panel may be a gamepad, and the means for feeding commands to the controller comprise control buttons such as a glider mode button for sending a control signal to the front operating motor to turn the wings of the VTOL UAV in a position where the propellers of the rotors on the wings operate in a plane perpendicular to the horizon, a drone mode button for sending a control signal to the front operating motor to turn the wings of the VTOL UAV in a position where the propellers of the rotors on the wings operate in a plane parallel to the horizon, a pitch increase button configured to send a control signal to the front and rear operating motors to respectively turn the bar and the arm, and to the front or rear rotor to respectively increase the lifting force to thus lift the respective front or rear part of the body, and a pitch decrease button configured to send a control signal to the front and rear operating motors to respectively turn the bar and the arm, and to the front or rear rotor to decrease or equalize the lifting forces generated by the front and rear rotors to thus return the body in less pitched state or in the state before the pitch increase button was pressed.

Also, the present disclosure also relates to an unmanned aerial system (UAS), comprising the VTOL UAV according to the second embodiment, and a remote control panel configured to send control signals to control the operation of the VTOL UAV.

In one particular embodiment, the remote control panel may comprise a housing that accommodates an emitter, a controller configured to communicate with the emitter to send operating signals to the VTOL UAV, and a user interface communicatively connected to the controller and comprising a means for feeding commands to the controller.

The remote control panel may be a gamepad, and the means for feeding commands to the controller comprise control buttons such as a glider mode button for sending a control signal to the operating motor to turn all pairs of wings of the VTOL UAV in a position where the propellers of each rotor of each wing operate in a plane perpendicular to the horizon, a drone mode button for sending a control signal to the operating motor to turn all pairs of wings of the VTOL UAV in a position where the propellers of each rotor of each wing operate in a plane parallel to the horizon, a pitch increase button configured to send a control signal to the operating motor to turn the bars, and to the front or rear rotors to respectively increase the lifting force to thus lift the respective front or rear part of the body, and a pitch decrease button configured to send a control signal to the operating motor to turn the bars, and to the front or rear rotor to decrease or equalize the lifting forces generated by the front and rear rotors to thus return the body in the less pitched state or in the state before the pitch increase button was pressed.

The features, functions and advantages of the disclosure that have been discussed can be achieved independently in various embodiments of the present disclosure or may be combined in yet other embodiments, further details of which can be seen with reference to the following description and drawings below.

### BRIEF DESCRIPTION OF THE DRAWINGS

FIG. 1 shows the interior arrangement of a VTOL UAV according to the first embodiment.

FIG. 2 shows the VTOL UAV of FIG. 1 in a glider mode.

FIG. 3 shows the VTOL UAV of FIG. 1 in a drone mode.

FIGS. 4A and 4B show the VTOL UAV of FIG. 1 hovering in a drone mode at an angle 45° and at an angle 60° to the horizon respectively.

FIG. 5 shows the interior arrangement of a VTOL UAV according to the second embodiment.

FIG. 6 shows the VTOL UAV of FIG. 5 in a glider mode.

FIG. 7 shows the VTOL UAV of FIG. 5 in a drone mode.

FIGS. 8A and 8B show the VTOL UAV of FIG. 5 hovering in a drone mode at an angle 45° and at an angle 60° to the horizon respectively.

FIG. 9 shows a remote control panel controlling the operation of the VTOL UAV according to the embodiments disclosed in the present disclosure.

### DETAILED DESCRIPTION OF THE INVENTION

Preferred embodiments and aspects of the present invention will be presented and described below with reference to the accompanying drawings.

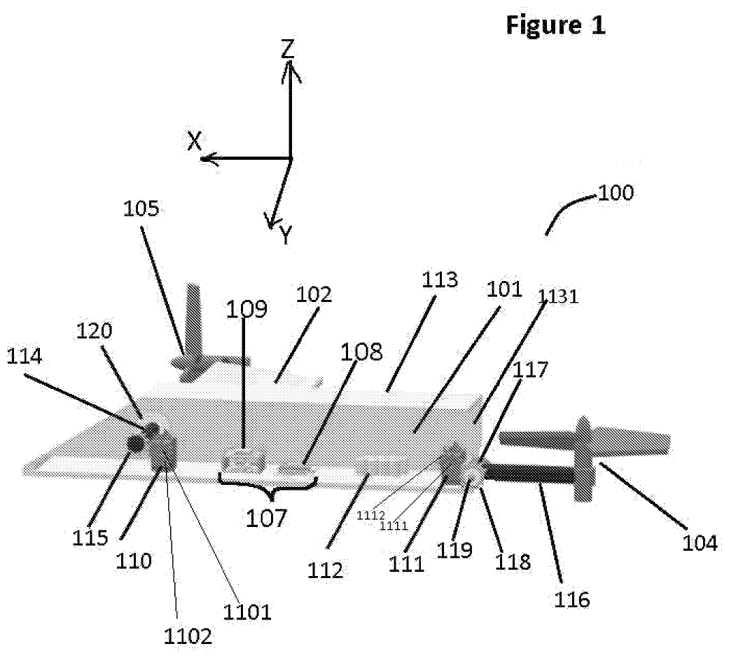

The vertical take-off and landing unmanned aerial vehicle (VTOL UAV) 100 in accordance with the first embodiment is shown on FIGS. 1-4. The VTOL UAV 100 comprises a body 101, a pair of wings 102, 103 pivotably attached to the body 101, and rear rotor 104 pivotably attached to the body and, when in use, oriented vertically. At least one pair of front rotors 105, 106 is mounted on the wings 102,103. Each of the front rotors 105, 106 and the rear rotor 104 comprises a motor and a propeller.

A flight control unit 107 is accommodated in the body 101. The flight control unit 107 comprises a receiver 108 configured to receive a control signal, and a controller 109 configured to process the control signal received by the receiver 108 and to operate the motors of the rear and front rotors 104 and 105, 106. Further, the UAV 100 comprises a front operating motor 110 arranged in the body 101 and connected with the pair of wings 102, 103 to turn them with respect to the body 101, and a rear operating motor 111 connected with the rear rotor 104 to turn the rear rotor 104 with respect to the body 101.

The controller 109 of the flight control unit 107 is communicatively coupled with the front operating motor 110 and the rear operating motor 111 to operate them based on the control signal received by the receiver 108. The VTOL UAV 100 further comprises a power source 112 accommodated in the body 101 and configured to supply power to the receiver 108 and the controller 109 of the flight control unit 107.

In a preferred embodiment, the body 101 comprises a rigid structure such as support frame 113 configured to accommodate the flight control unit 107, and the pair of wings 102, 103 is pivotably attached to the frame 113, e.g. by means of bearings 120 arranged in the frame 113. Further, the VTOL UAV 100 may comprise a bar 114 transversely (i.e. along the axis Y) passing through the body 101 and rotatably mounted in the frame 113, wherein the wings 102, 103 of the pair of wings are fixedly connected to the bar 114, and the bar 114 comprises a gear wheel 115. The front operating motor 110 comprises a shaft 1101 and a gear wheel 1102 arranged thereon, wherein the gear wheel 1102 of the front operating motor 110 engages (meshes) with the gear wheel 115 of the bar 114. In addition, the front rotors 105, 106 comprise housings accommodating the motors, and the housings of the front rotors 105, 106 are fixedly mounted on the opposite ends of the bar 114. Therefore, as far as the wings 102, 103 are fixedly connected to the bar 114 and the front rotors 105, 106 are fixedly mounted on the opposite ends of the bar 114, rotation of the gear wheel 1102 will lead to corresponding rotation of the gear wheel 115 and, consequently, to the rotation of the bar 114, the wings 102, 103 and the rotors 105, 106, respectively. Thus, VTOL UAV 100 realizes simple and simultaneous operation of the wings 102, 103 and the front rotors 105, 106.

In particular, the frame 113 of the body 101 may comprise side walls 1131, 1132. A pair of bearings 120 is mounted in the side walls 1131, 1132, and the bar 114 is rotatably mounted on the frame 113 of the body 101 by means of said bearings 120.

Further preferably, the rear rotor 104 comprises a housing accommodating the motor of the rear rotor 104, and the VTOL UAV 100 further comprises an arm 116. One end of said arm 116 is pivotably connected to the housing of the rear rotor 104 and the other end is pivotably connected to the frame 113 of the body 101. A rear transmission unit 117 is placed in the area of connection of the frame 113 and the arm 116. The rear transmission unit 117 comprises a rear gear wheel 118 and a pin 119 fixedly connected with the rear gear wheel 118. By means of said pin 119, which could be, for example, cylindrical, the arm 116 is connected with the rear gear wheel 118. The rear operating motor 111 also comprises a shaft 1111 and a gear wheel 1112 arranged thereon, wherein the gear wheel 1112 is in communication with the rear gear wheel 118. Thus, the rotation of the gear wheel 1112 of the rear operating motor 111 will lead to corresponding rotation of the rear gear wheel 118 and, consequently, to the rotation of the pin 119 and, thus, to turning the arm 116 with the rear rotor 104, which can be described turn the body 101 with respect to the rear rotor 104.

In the first embodiment of the VTOL UAV, the controller 109 of the flight control unit 107 is configured to control the front rotors 105, 106 and the rear rotor 104 by feeding them with power received from the power source 112. Preferably, the power source 112 is an electric power source, for example a battery.

The front and the rear operating motors 110, 111 may be servomotors.

The receiver 108 is a GPS antenna.

Another object of the present disclosure is an unmanned aerial system (UAS), comprising the VTOL UAV 100 in accordance with one or more embodiments described above, and a remote control panel 300 configured to send control signals to control the operation of the VTOL UAV 100.

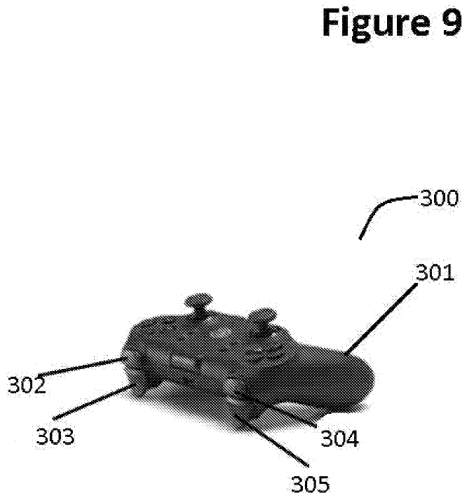

The abovementioned remote control panel 300 is designed as a conventional remote control panel, for example a gamepad or a tablet, having some distinctive features providing simple operation. An exemplary illustration of the remote control panel 300 is provided on FIG. 9.

In a preferred embodiment, the remote control panel 300 comprises a housing 301 that accommodates an emitter, a controller configured to communicate with the emitter to send operating signals to the VTOL UAV 100, and a user interface communicatively connected to the controller and comprising a means for feeding commands to the controller.

Such means for feeding commands may comprise control buttons 302-305 for switching the VTOL UAV 100 between different modes, such as: a glider mode button 302, a drone mode button 303, a pitch increase button 304 and a pitch decrease button 305. The glider mode button 302 is configured to send a control signal to the front operating motor 110 to turn the wings 102, 103 of the VTOL UAV 100 in a position where the propellers of the rotors 105, 106 on the wings 102, 103 operate in a plane perpendicular to the horizon. The drone mode button 303 is configured to send a control signal to the front operating motor 110 to turn the wings 102, 103 of the VTOL UAV 100 in a position where the propellers of the rotors 105, 106 on the wings 102, 103 operate in a plane parallel to the horizon. The pitch increase button 304 is configured to send a control signal to the front and rear operating motors 110, 111 to respectively turn the bar 114 and the arm 116, and to the front 105, 106 rotors or rear rotor 104 to respectively increase the lifting force to thus lift the respective front or rear part of the body 101 of the VTOL UAV 100. The pitch decrease button 305 is configured to send a control signal to the front and rear operating motors 110, 111 to respectively turn the bar 114 and the arm 116, and to the front rotors 105, 106 or rear rotor 104 to decrease or equalize the lifting forces generated by the front rotors 105, 106 and rear rotor 104 to thus return the body 101 in less pitched state or in the state before the pitch increase button 304 was pressed.

However, it is to be noted that although the user interface comprises the means for feeding commands, it may comprise common control means, such as sticks for controlling the direction/altitude, means for controlling power of the rotors, power switch, etc. Also, a display can be integrated in the remote control panel 300.

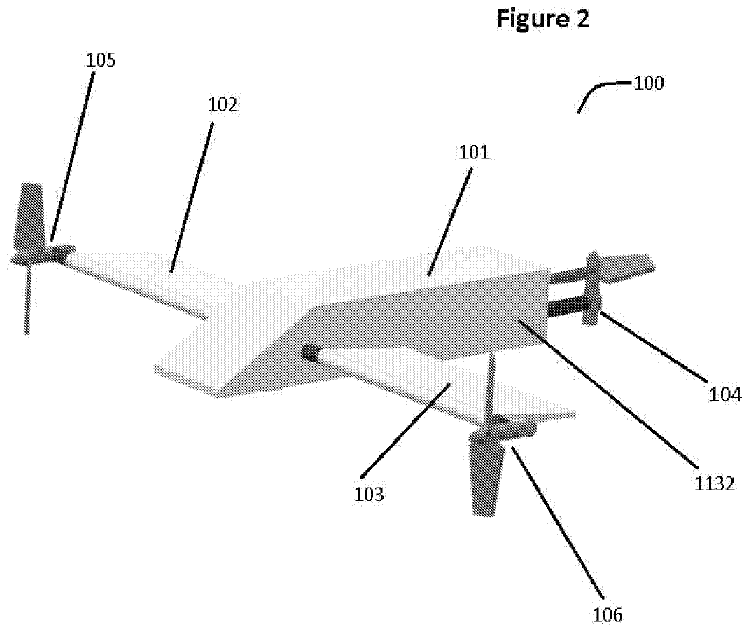

Below, the operation of the VTOL UAV 100 will be described with the reference to the FIGS. 2 (glider mode), 3 (drone mode with horizontal hovering) and 4A, 4B (hovering at an angle mode).

FIG. 2 illustrates the VTOL UAV 100 in the glider mode that enables horizontal flight. In this mode, the wings 102, 103 are oriented parallel to the horizon and provide favorable effect on the efficiency of the vehicle, since the front rotors 105, 106 create forward thrust when activated. Due to this, the wings 102, 103 produce a lifting force that causes the VTOL UAV 100 to fly. Since the wings 102, 103 produce the lifting force, less power is needed to realize the horizontal flight in comparison with conventional drones that do not have wings. The rear rotor 104 does not receive power from the power source 112 in this mode. Therefore, the energy efficiency and extended operating time are achieved.

In addition, the presence of three different modes (the drone mode, the glider mode and the hovering at an angle mode) in one vehicle and the ability of rotating the wings 102, 103 allow for a new technique of operating the VTOL UAV 100. In particular, when there is a need to increase the altitude at which the VTOL UAV 100 flies in the glider mode or hovers in the drone mode, small temporary pitch should be added by rotating the wings 102, 103 by a few degrees. For example, when in the glider mode or in the drone mode, the body 101 of the VTOL UAV 100 is parallel to the horizon (balanced at 0° with respect to the horizontal plane defined by longitudinal axis X and transversal axis Y), to increase the altitude the operator needs to pitch the body 101 by rotating the wings 102, 103 at, for example, 1.8° or more depending on the required speed of raising the altitude. Alternatively, when there is a need to decrease the altitude, pitch of the body 101 should be reduced by rotating the wings 102, 103 by a few degrees. Rotating of the wings is realized by pressing the pitch increase button 304 or pitch decrease button 305 of the user interface of the remote control panel 300, that sends a signal to the front operating motor 110 to turn the bar 114.

Further, the construction of the vehicle provides another option for lowering the altitude. When the VTOL UAV 100 is in the glider mode, turning on the rear rotor 104 leads to pitching the body 101 of the VTOL UAV 100 as far as it raises the rear part of the body 101. Thus, the wings 102, 103 become inclined downwards and the VTOL UAV 100 starts descent in altitude. When the desired descent is achieved, the rear rotor 104 is turned off and the VTOL UAV 100 returns in balanced position in the glider mode.

Navigation of the VTOL UAV 100 is achieved by changing thrust of the right and left front rotors 105, 106. If there is a need to turn left, thrust of the right rotors should be increased, and vice versa.

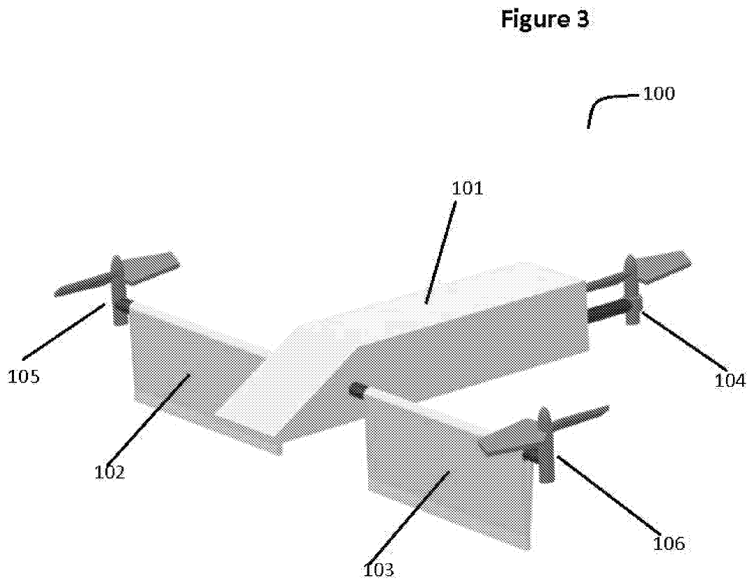

FIG. 3 illustrates the VTOL UAV 100 in the drone mode that enables vertical take-off and landing, as well as hovering. In this mode, the wings 102, 103 are oriented perpendicular to the horizon, which is provided by the 90°-rotation of the bar 114 holding the wings 102, 103 and the front rotors 105, 106. This rotation of the wings 102, 103 with front rotors 105, 106 can be easily achieved by pressing the drone mode button 303 on the remote control panel. In this mode, all the rotors 104, 105, 106 of the VTOL UAV 100 are turned on and generate thrust of specific values thus providing vertical take-off and landing or hovering. The VTOL UAV 100 being in the drone mode can be controlled as any other conventional drone.

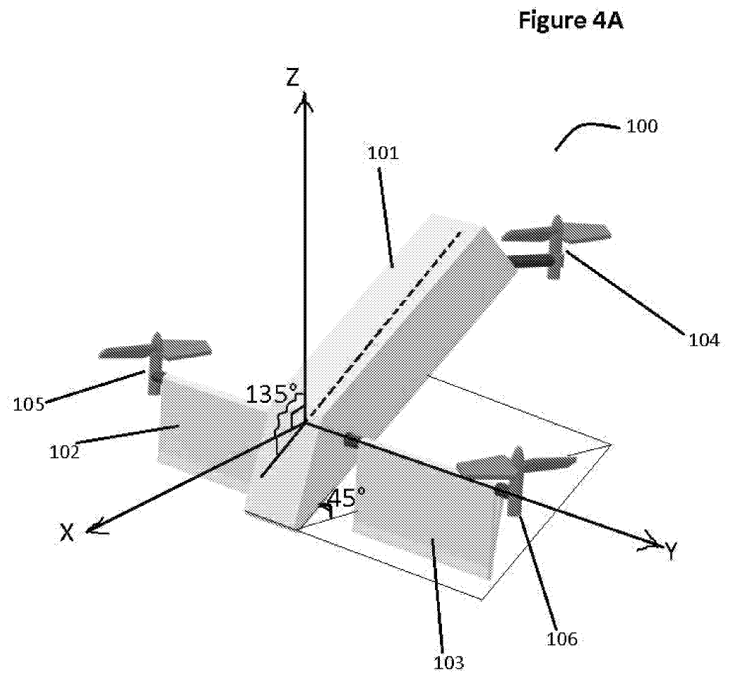

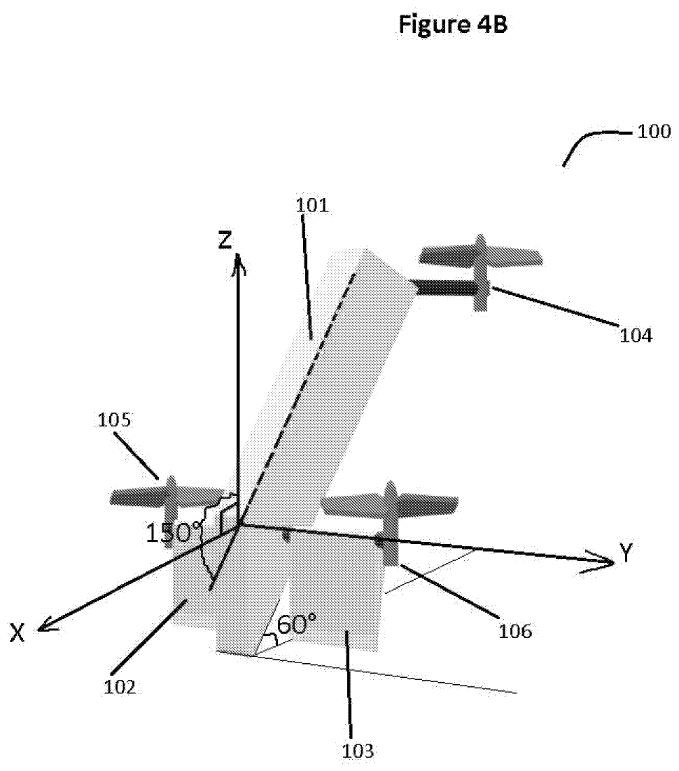

FIGS. 4A and 4B illustrates the VTOL UAV 100 in the hovering at an angle mode. In the context of the present disclosure, “the hovering at an angle mode” means the mode of hovering with the body 101 of VTOL UAV 100 pitched to the horizon, wherein “horizon” is a plane defined by longitudinal axis X and transversal axis Y. For example, FIG. 4A represents the VTOL UAV 100 hovering at an angle of 45° to the horizon, and FIG. 4B represents the VTOL UAV 100 hovering at an angle of 60° to the horizon. From the figures, it is evident that in the hovering at an angle mode front and rear parts of the VTOL UAV 100 have different coordinate along vertical axis Z (“VZ-TOL”).

Switching from the drone mode to the hovering at an angle mode is activated by the pitch increase button. When the VTOL UAV 100 is in the drone mode, the propellers of the front rotors 105, 106 and of the rear rotor 104 operate in the plane parallel to the horizon, the wings 102, 103 are perpendicular to the horizon, and the body 101 of the VTOL UAV 100 is parallel to the horizon. To switch the VTOL UAV 100 to the hovering at an angle mode, the body 101 of the VTOL UAV 100 should be pitched, while the wings 102, 103 should remain perpendicular to the horizon, and the propellers of the front rotors 105, 106 and of the rear rotor 104 should continue operating in the plane parallel to the horizon. This is achieved by coordinated turning the bar 114 with the wings 102, 103 and front rotors 105, 106 and the arm 116 with the rear rotor 104 in response to the signal received by receiver 108 of the VTOL UAV 100 from the emitter of the remote control panel 300.

Pitch increase and pitch decrease depend on the time of pressing the respective pitch increase button 304 or pitch decrease button 305. The change of the pitch and, therefore, the angle of the body 101 of the VTOL UAV 100 depends on the configuration of the gear wheel 115 rotating the bar 114 and the rear gear wheel 118 turning the arm 116. The more times/the longer the operator presses the respective button, the greater angle change will be reached.

In order to provide stable hovering at an angle, the VTOL UAV 100 should be properly balanced. This balancing is provided by changing the thrust of the rotors in response to the control signal from the controller 109. The VTOL UAV 100 can also comprise few sensors, such as accelerometers (g-meters), gyroscopes et al., communicatively coupled with the controller 109 whereas the controller 109 is configured to process data received from the sensors in order to generate the control signal to correct the thrust of the rotors.

Also, the construction of VTOL UAV 100 provides immediate change of the modes. For example, there is the glider mode button 302 that, being once pressed in any other mode, rotates the wings 102, 103 with the front rotors 105, 106 and, if needed, turns the arm 116 with the rear rotor 104 in position where the propellers of all rotors 104, 105, 106 are parallel to the horizon. The drone mode button 303 is configured to change the position of the wings 102, 103 and of the arm 116 to provide immediate switching of the VTOL UAV 100 to the drone mode from any other mode. For this purpose, the VTOL UAV can comprise different detectors measuring the angle of the respective part of the VTOL UAV 100 (for example, detecting positions of gear wheels 115 or 118, or angle of the wings 102, 103 or of the arm 116 with respect to the body 101, etc.). The information received from such sensors is processed by the controller 109, and then the controller 109 sends new signal to the respective operating motor 110 or 111 to rotate the bar 114 or the arm 116 to specified angle to reach the desired mode immediately.

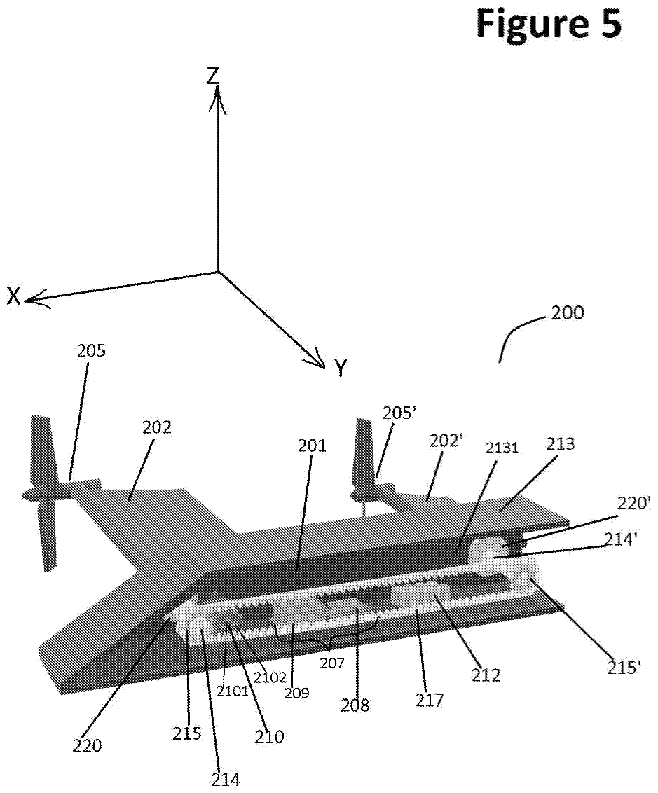

The vertical take-off and landing unmanned aerial vehicle (VTOL UAV) 200 in accordance with the second embodiment is shown on FIGS. 5-8. The VTOL UAV 200 comprises a body 201 and at least two pairs of wings: front wings 202, 203 and rear wings 202′, 203′, wherein the wings are pivotably attached to the body 201. Each wing 202, 203, 202′,203′ comprises at least one rotor: front rotors 205, 206 and rear rotors 205′, 206′, respectively. Each of the front rotors 205, 206 and the rear rotors 205′, 206′ comprises a motor and a propeller.

A flight control unit 207 is accommodated in the body 201. The flight control unit 207 comprises a receiver 208 configured to receive a control signal, and a controller 209 configured to process the control signal received by the receiver 208 and to operate the motors of the rear and front rotors 205, 206, 205′, 206′. Further, one operating motor 210 is arranged in the body 201 and connected with the pairs of wings 202, 203, 202′, 203′ to turn them with respect to the body 201, wherein all pairs of wings are connected with each other to be simultaneously turned.

The controller 209 of flight control unit 207 is communicatively coupled with the operating motor 210 to operate it based on the control signal received by the receiver 208. The VTOL UAV 200 further comprises a power source 212 accommodated in the body 201 and configured to supply power to the receiver 208 and the controller 209 of the flight control unit 207.

The body 201 comprises a rigid structure such as support frame 213 configured to accommodate the flight control unit 207, and all pairs of wings 202, 203, 202′, 203′ are pivotably attached to the frame 213, e.g. by means of bearings 220, 220′ arranged in the frame 213. Further, the VTOL UAV 200 may comprise bars 214, 214′ transversely (i.e. along axis Y) passing through the body 201 and rotatably mounted in the frame 213, wherein the wings 202, 203, 202′, 203′ in each pair of wings are fixedly connected to the respective bar 214, 214′, and the bars 214, 214′ comprise gear wheels 215, 215′. Along with that, the VTOL UAV 200 comprises a transmission unit 217 movably arranged in the body 201. The operating motor 210 comprises a shaft 2101 and a gear wheel 2102 arranged thereon, whereas the gear wheel 2102 of the operating motor 210 directly engages with one gear wheel 215 or 215′ of the bar 214 or 214′, and the transmission unit 217 is arranged to movably connect the gear wheels 215, 215′ with each other. In addition, the rotors 205, 206 and 205′, 206′ comprise housings accommodating the motors, and the housings of the rotors 205, 206 and 205′, 206′ are fixedly mounted on the opposite ends of the bars 214 and 214′, respectively. Therefore, as far as the wings 202, 203 and 202′, 203′ are fixedly connected to the bars 214 and 214′, respectively, and the rotors 205, 206 and 205′, 206′ are fixedly mounted on the opposite ends of the bars 214 and 214′, respectively, rotation of the gear wheel 2102 will lead to corresponding rotation of one gear wheel 215 or 215′ and, consequently, to the motion of the transmission unit 217 and to the rotation of other gear wheel 215′ or 215. Then, the bars 214, 214′, the wings 202, 203, 202′, 203′ and the rotors 205, 206, 205′, 206′ are also turned. Thus, simple and simultaneous operation of the wings 202, 203, 202′, 203′ and the rotors 205, 206, 205′, 206′ is realized in the VTOL UAV 200.

In particular, the frame 213 of the body 201 may comprise side walls 2131, 2132. Pairs of bearings 220, 220′ are mounted in the side walls 2131, 2132, and the bars 214, 214′ are rotatably mounted on the frame 213 of the body 201 by said bearings 220, 220′.

In the second embodiment of the VTOL UAV, the controller 209 of the flight control unit 207 is configured to control the rotors 205, 206, 205′, 206′ by feeding them with power received from the power source 212. Preferably, the power source 212 is an electric power source, for example a battery. In further preferred embodiment of the second embodiment of the VTOL UAV, the operating motor 210 is servomotor. In further preferred embodiment of the second embodiment of the VTOL UAV, the receiver 208 is a GPS antenna.

Another object of the present disclosure is an unmanned aerial system (UAS), comprising the VTOL UAV 200 in accordance with one or more embodiments as described above, and a remote control panel 300 configured to send control signals to control the operation of the VTOL UAV 200.

The abovementioned remote control panel 300 can be designed as the remote control panel 300 provided on FIG. 9 for the first embodiment. Thus, the main elements and buttons of the control panel 300 are the same as discussed in the above disclosure.

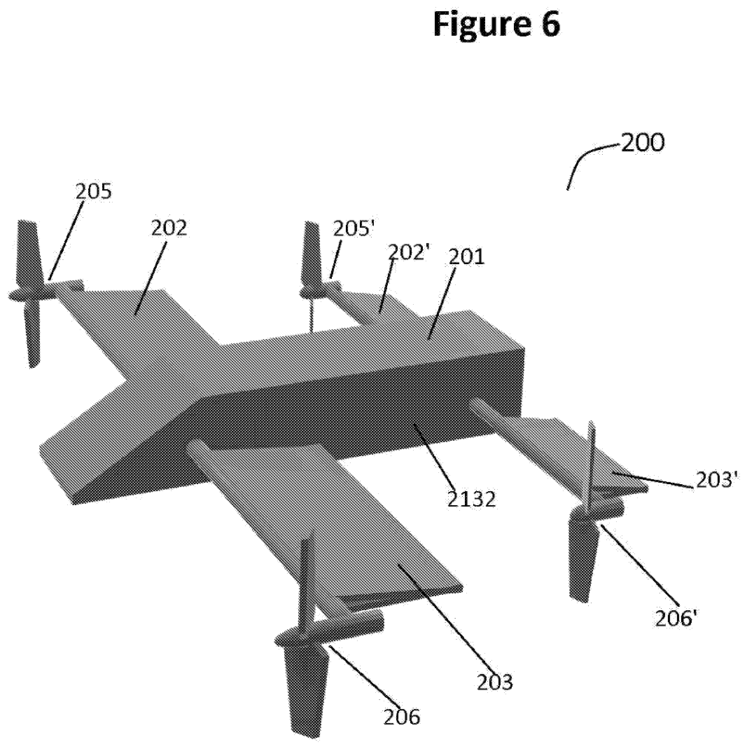

In particular, the glider mode button 302 is configured to send the signal to the operating motor 210 to rotate the bar 214 or 214′ in order to switch the VTOL UAV 200 from any mode to the glider mode, where the body 201 and all the wings 202, 203, 202′, 203′ are parallel to the horizon, and the propellers of the rotors 205, 206, 205′, 206′ are operated in the plane that is perpendicular to the horizon. The VTOL UAV 200 in the glider mode is illustrated on FIG. 6.

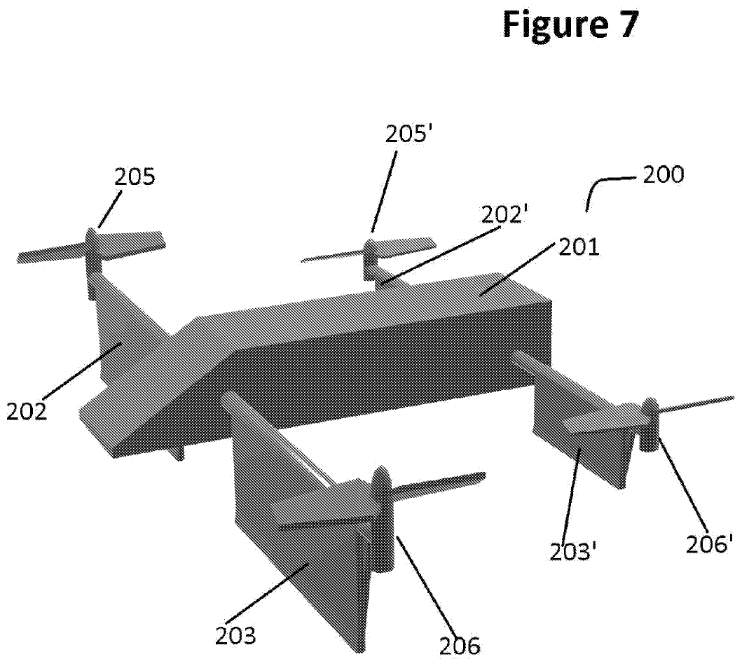

The drone mode button 303 is configured to send the signal to the operating motor 210 to rotate the bars 214, 214′ in order to switch the VTOL UAV 200 from any mode to the drone mode, where the body 201 is parallel to the horizon, wherein all the wings 202, 203, 202′, 203′ are perpendicular to the horizon and to the body 201, thus, the propellers of the rotors 205, 206, 205′, 206′ are operated in the plane that is parallel to the horizon. The VTOL UAV 200 in the drone mode is illustrated on FIG. 7.

The pitch increase button 304 is configured to send the control signal to the operating motor 210 to turn the bars 214, 214′, and to the front rotors 205, 206 or rear rotors 205′, 206′ to respectively increase the lifting force to thus lift the respective front or rear part of the body 201 of the VTOL UAV 200.

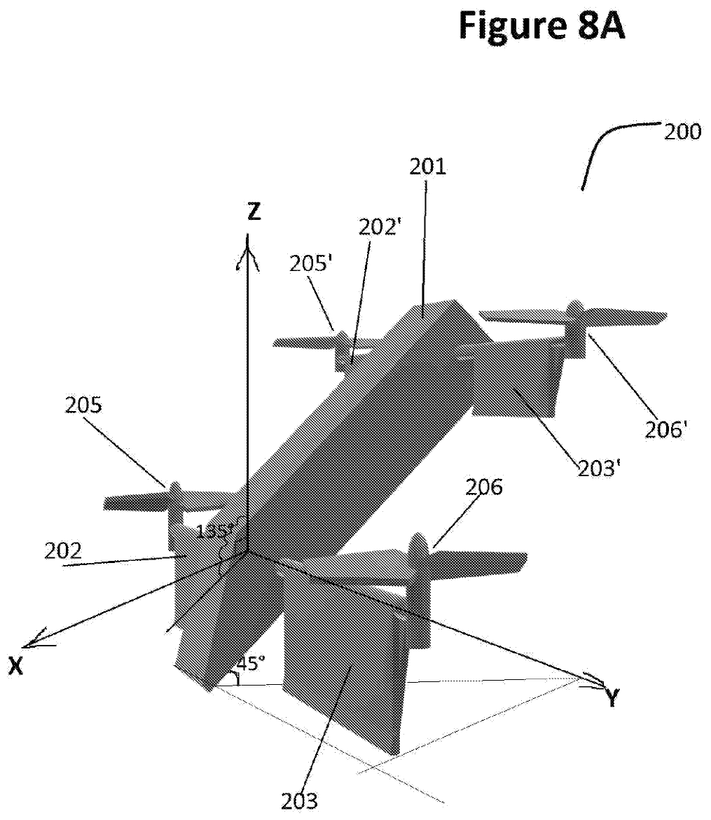

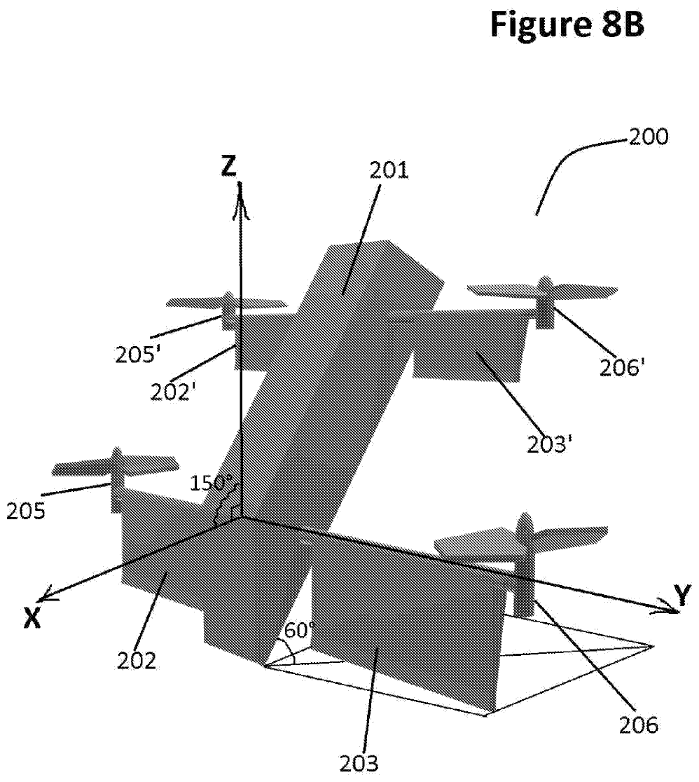

The pitch decrease button 305 is configured to send the control signal to the operating motor 210 to turn the bars 214, 214′, and to the front rotors 205, 206 or rear rotors 205′, 206′ to respectively decrease or equalize the lifting force to return the respective front or rear part of the body 201 in less pitched state or in the state before the pitch increase button 304 was pressed. FIGS. 8A and 8B represents the VTOL UAV 200 in the hovering mode at an angle 45° and 60°, respectively.

It is to be noted that the number of pairs of wings in the second embodiment of the VTOL UAV 200 is not limited, as well as the number of bars and gear wheels (which is equal to the number of the pairs of wings) and the number of rotors, respectively. If there are more than two pairs of wings, the number of the operating motors required for correct operation is still one, as far as all the pairs of the wings are connected to be simultaneously turned by means of the transmission unit 217.

Also, there can be the embodiments combining the first and the second embodiments, for example, the VTOL UAV having five, seven or more rotors. Such vehicle will comprise both the transmission unit similar to the transmission unit 217 and connecting the bars rotating two, three or more pairs of wings simultaneously, and the rear transmission unit similar to the rear transmission unit 117 and turning the arm with the rear rotor in response to the control signal.

Thus, the above-described invention provides the vertical take-off and landing unmanned aerial vehicle and the vertical take-off and landing unmanned aerial system, which provide:
1) vertical take-off and landing, making the operation more effective in limited space,
2) horizontal flight, providing the opportunity to achieve higher speed in comparison with conventional drones and, therefore, expanding the area of use,
3) hovering both horizontally and at an angle, allowing for effective use of specific equipment without additional means;
4) simplified control of the equipment installed on the vehicle;
5) energy efficiency due to lightening of the vehicle;
6) extended operating time.

### LIST OF REFERENCES NUMERALS

The following reference numerals are used in the drawings:
100—VTOL UAV (the first embodiment);
200—VTOL UAV (the second embodiment);
300—remote control panel;
101, 201—body;
102, 103—wing;
202, 203—front wings
202′ 203′—rear wing;
104—rear rotor;
105, 106, 205, 206—front rotor;
205′, 206′—rear rotor;
107, 207—flight control unit;
108, 208—receiver;
109, 209—controller;
110—front operating motor;
210—operating motor;
111—rear operating motor;
1101, 1111, 2101—shafts of the operating motor;
1102, 1112, 2102—gear wheels of the operating motor;
112, 212—power source;
113, 213—frame;
1131, 1132, 2131, 2132—side wall;
114, 214, 214′—bar;
115, 215, 215′—gear wheel;
116—arm;
117—rear transmission unit;
217—transmission unit
118—rear gear wheel;
119—pin;
120, 220, 220′—bearing;
301—housing;
302—glider mode button;
303—drone mode button;
304—pitch increase button;
305—pitch decrease button;
X—longitudinal axis;
Y—transversal axis;
Z—vertical axis.

1. A vertical take-off and landing (VTOL) unmanned aerial vehicle (UAV), comprising:
a body,
a pair of wings pivotably attached to the body,
at least one pair of front rotors mounted on the wings, each of the front rotors comprises a motor and a propeller,
a rear rotor pivotably attached to the body and, when in use, oriented vertically, the rear rotor comprises a motor and a propeller,
a flight control unit accommodated in the body, the flight control unit comprises
a receiver configured to receive a control signal,
a controller configured to process the control signal received by the receiver and to operate the motors of the front and rear rotors,
a front operating motor connected with the pair of wings to turn them with respect to the body,
a rear operating motor connected with the rear rotor to turn the rear rotor with respect to the body, wherein
the controller is communicatively coupled with the front and rear operating motors to operate them based on the control signal received by the receiver, and
the VTOL UAV further comprises a power source accommodated in the body and configured to supply power to the receiver and the controller of the flight control unit.

2. The VTOL UAV according to claim 1, characterized in that the body comprises a frame configured to accommodate the flight control unit, and the pair of wings is pivotably attached to the frame.

3. The VTOL UAV according to claim 2, characterized in that it comprises a bar transversely passing through the body and rotatably mounted in the frame, wherein the wings of the pair of wings are fixedly connected to the bar, and the bar comprises a gear wheel,
the front operating motor comprises a shaft and a gear wheel arranged thereon, wherein the gear wheel of the front operating motor engages with the gear wheel of the bar,
the front rotors comprise housings accommodating the motors, and the housings of the front rotors are fixedly mounted on the opposite ends of the bar,
the rear rotor comprises a housing accommodating the motor of the rear rotor, and
the VTOL UAV further comprises an arm, wherein one end of the arm is pivotably connected to the housing of the rear rotor, and the other end of the arm is pivotably connected to the frame.

4. The VTOL UAV according to claim 3, characterized in that the frame comprises side walls, and the bar is rotatably mounted on the frame of the body by bearings mounted in the side walls.

5. The VTOL UAV according to claim 1, characterized in that the controller is configured to control the front rotors and the rear rotor by feeding them with power received from the power source.

6. The VTOL UAV according to claim 1, characterized in that the front and the rear operating motors are servomotors.

7. The VTOL UAV according to claim 1, characterized in that the receiver is a GPS antenna.

8. A vertical take-off and landing (VTOL) unmanned aerial vehicle (UAV), comprising:
a body,
at least two pairs of wings pivotably attached to the body, comprising at least one pair of front wings and at least one pair of rear wings,
at least one pair of front rotors mounted on the at least one pair of front wings,
at least one pair of rear rotors mounted on the at least one pair of rear wings,
wherein each of the rotors comprises a motor and a propeller,
a flight control unit accommodated in the body, the flight control unit comprises
a receiver configured to receive a control signal,
a controller configured to process the control signal received by the receiver and to operate the motors of the rotors,
an operating motor connected with one pair of wings to turn them with respect to the body, wherein all pairs of wings are connected with each other to be simultaneously turned, and wherein
the controller is communicatively coupled with the operating motor to operate it based on the control signal received by the receiver, and
the VTOL UAV further comprises a power source accommodated in the body and configured to supply power to the receiver and the controller of the flight control unit.

9. The VTOL UAV according to claim 8, characterized in that the body comprises a frame configured to accommodate the flight control unit, and the pairs of wings are pivotably attached to the frame.

10. The VTOL UAV according to claim 9, characterized in that it comprises at least two bars transversely passing through the body and rotatably mounted in the frame, the number of the bars is equal to the number of the pairs of wings, the wings of each pair of wings are fixedly connected to the respective bar, and each bar comprises a gear wheel,
a transmission unit movably arranged in the body, wherein
the operating motor comprises a shaft and a gear wheel arranged thereon, and
the transmission unit is arranged to movably connect the gear wheels with each other.

11. The VTOL UAV according to claim 10, characterized in that the frame comprises side walls, and the bars are rotatably mounted on the frame of the body by bearings mounted in the side walls.

12. The VTOL UAV according to claim 11, characterized in that each of the front rotors and the rear rotors comprises a housing accommodating the motor of the respective rotor, and the housings are fixedly mounted on the opposite ends of the respective bar.

13. The VTOL UAV in accordance with claim 9, characterized in that the controller is configured to operate the rotors by feeding them with power received from the power source.

14. The VTOL UAV according to claim 9, characterized in that the operating motor is a servomotor.

15. The VTOL UAV according to claim 9, characterized in that the receiver is a GPS antenna.

16. An unmanned aerial system (UAS), comprising
a vertical take-off and landing (VTOL) unmanned aerial vehicle (UAV) in accordance with one of claims 1-7, and
a remote control panel configured to send control signals to control the operation of the VTOL UAV.

17. The UAS according to claim 16, characterized in that the remote control panel comprises:
a housing that accommodates
an emitter,
a controller configured to communicate with the emitter to send operating signals to the VTOL UAV,
a user interface communicatively connected to the controller and comprising a means for feeding commands to the controller.

18. The UAS according to claim 17, characterized in that the means for feeding commands to the controller comprises:
a glider mode button for sending a control signal to the front operating motor to turn the wings of the VTOL UAV in a position where the propellers of the rotors on the wings operate in a plane perpendicular to the horizon,
a drone mode button for sending a control signal to the front operating motor to turn the wings of the VTOL UAV in a position where the propellers of the rotors on the wings operate in a plane parallel to the horizon,
a pitch increase button configured to send a control signal to the front and rear operating motors to respectively turn the bar and the arm, and to the front or rear rotor to respectively increase the lifting force to thus lift the respective front or rear part of the body, and
a pitch decrease button configured to send a control signal to the front and rear operating motors to respectively turn the bar and the arm, and to the front or rear rotor to decrease or equalize the lifting forces generated by the front and rear rotors to thus return the body in less pitched state or in the state before the pitch increase button was pressed.

19. An unmanned aerial system (UAS), comprising
a vertical take-off and landing (VTOL) unmanned aerial vehicle (UAV) in accordance with one of claims 8-15, and
a remote control panel configured to send control signals to control the operation of the VTOL UAV.

20. The UAS according to claim 19, characterized in that the remote control panel comprises:
a housing that accommodates
an emitter,
a controller configured to communicate with the emitter to send operating signals to the VTOL UAV,
a user interface communicatively connected to the controller and comprising a means for feeding commands to the controller.

21. The UAS according to claim 20, characterized in that the means for feeding commands to the controller comprise:
a glider mode button for sending a control signal to the operating motor to turn all pairs of wings of the VTOL UAV in a position where the propellers of each rotor on each wing operate in a plane perpendicular to the horizon,
a drone mode button for sending a control signal to the operating motor to turn all pairs of wings of the VTOL UAV in a position where the propellers of each rotor on each wing operate in a plane parallel to the horizon,
a pitch increase button configured to send a control signal to the operating motor to turn the bars, and to the front or rear rotors to respectively increase the lifting force to thus lift the respective front or rear part of the body, and
a pitch decrease button configured to send a control signal to the operating motor to turn the bars, and to the front or rear rotor to decrease or equalize the lifting forces generated by the front and rear rotors to thus return the body in less pitched state or in the state before the pitch increase button was pressed.
